(19) United States
(12) Patent Application Publication
(10) Pub. No.: US 2014/0251152 A1
(43) Pub. Date: Sep. 11, 2014

(54) BEVERAGE CONTAINER SUITABLE FOR MAKING COLD OR HOT BEVERAGE

(71) Applicant: Jung-Jung TIEN, Taipei City (TW)

(72) Inventor: Jung-Jung TIEN, Taipei City (TW)

(21) Appl. No.: 13/789,757

(22) Filed: Mar. 8, 2013

(51) Int. Cl. A47J 31/18

(52) U.S. Cl. CPC A47J 31/18
USPC 99/322

(57) ABSTRACT

The present invention is to provide a beverage container suitable for making cold or hot beverage, which includes a container body having an opening at a top side thereof and a first receiving space therein in communication with the opening and configured for receiving a cold or hot liquid, an outer lid being disposed at the top side of the container body for covering the opening, a filter having a second receiving space therein for receiving a brewing material and having a top side detachably connected to a bottom side of the outer lid, and an inner lid being detachably connected to the container body at a position corresponding to the top end of the first receiving space and having a primary and a secondary liquid guiding holes provided on two opposite lateral sides thereof respectively. The primary liquid guiding hole is larger than the secondary liquid guiding hole.

### FIELD OF THE INVENTION

The present invention is to provide a beverage container suitable for making cold or hot beverage, which includes a container body having an opening at a top side thereof and a first receiving space therein in communication with the opening and configured for holding a cold or hot liquid, an outer lid being disposed at the top side of the container body for covering the opening, a filter having a second receiving space therein for receiving a brewing material and having a top side detachably connected to a bottom side of the outer lid, and an inner lid being detachably connected to the container body at a position corresponding to the top end of the first receiving space and having a primary and a secondary liquid guiding holes (the primary liquid guiding hole is larger than the secondary liquid guiding hole) thereon at two opposite lateral sides thereof respectively. Hence, by placing a brewing material into the second receiving space inside the filter, connecting the filter to the outer lid, and connecting the outer lid to the container body, infusion of the brewing material can take place in the first receiving space with either the cold or hot water according to the user's preference or need. When the user determines that a proper brewing time has elapsed, the filter can be detached from the outer lid and be replaced by the inner lid, the beverage container can then be tilted toward the primary or secondary liquid guiding hole. Thus, the user can sip the cold or hot beverage through the primary or secondary liquid guiding hole, accordingly.

### BACKGROUND OF THE INVENTION

Commercially available beverages usually contain a lot of chemical additives and are typically packaged in beverage containers designed for single use (e.g., the PET bottles, retort pouches, Tetra Pak cartons, and cans commonly seen in convenience stores; and paper cups, plastic cups, and styrofoam cups for use with hand-shaken beverages). If such beverages are consumed on a regular basis, not only may they cause health problems, but also the environment will be polluted. As people become more and more aware of health maintenance and environmental protection, many consumers tend to buy beverage containers designed for repeated use and make various cold or hot beverages by themselves to ensure personal health while enjoying tasty drinks and fulfill the social responsibility of environmental protection.

Nowadays, quite a few people carry beverage containers with them in order to be able to drink their favorite beverages whenever possible (e.g., on the road, during work hours, or in class). And because of that, beverage containers equipped with a filter were developed, allowing users to make the desired cold or hot drinks anywhere and at any time, using nothing else but the beverage containers they carry. While the beverage making function lends increased convenience and usefulness to such filter-equipped beverage containers, a careful analysis of consumer feedbacks has revealed that the conventional filter-equipped beverage containers still leave room for improvement, as explained below.

First of all, it is well known that all beverages made by brewing (e.g., coffee, tea, and various herbal teas) must undergo a brewing process in which the brewing material (e.g., tea leaves or ground coffee) releases different ingredients over time. Hence, whether the optimal flavors can be obtained depends on proper control of the temperature and duration of the brewing process. Taking a coffee brewing process for example, the first ingredients to be extracted in large amounts are those contribute to aroma and fruity acidity, whereas ingredients with a bitter or astringent taste are extracted from the coffee powder relatively slowly. Therefore, as the brewing process continues, the taste of the brew turns from mild sourness to slight bitterness. If the coffee powder is left too long in the brew, the resultant coffee will end up extremely bitter. By the same token, a good cup of tea or herbal tea cannot be obtained without controlling the brewing time properly. However, when a conventional filter-equipped beverage container is used to make a beverage, the brewing material is, in most cases, soaked in a liquid at all times such that, when the beverage is drunk at a much later time, the taste of the beverage is far from its optimal.

In addition, although a conventional filter-equipped beverage container can be used to make cold or hot drinks, the container body, which is configured for containing a beverage and is usually jar-like in order to accommodate a filter, may raise safety issues during use because, when a user drinks directly from the beverage container, the large opening of the container body tends to increase the flow rate of the beverage. If the beverage is hot, the drinker is very likely to be burned by the fast-flowing high-temperature flow. Needless to say, such a dangerous design needs betterment.

It can be known from the above that a user of a conventional filter-equipped beverage container often leaves the brewing material in a liquid for so long that the resultant beverage loses its optimal flavor. Moreover, as a conventional filter-equipped beverage container typically takes the form of a jar, a user who has made a hot beverage with the beverage container and wishes to drink directly therefrom stands a high chance of being burned by the high-temperature beverage, which is most undesirable. Therefore, the issue to be addressed by the present invention is to design a lid which not only can prevent the brewing material from soaking in a liquid for an excessive amount of time, but also allows hot as well as cold beverages made in a matching beverage container to be drunk safely and to the drinker's heart's content.

### BRIEF SUMMARY OF THE INVENTION

In view of the aforesaid disadvantages of the conventional filter-equipped beverage containers, the inventor of the present invention conducted extensive research and numerous tests based on not only the skills and knowledge acquired from years of service in the related industry, but also consumer feedbacks of existing products. Finally, a beverage container suitable for making cold or hot beverage was successfully developed and is disclosed herein. The present invention hopefully overcomes all the aforementioned design flaws of the conventional filter-equipped beverage containers.

It is an object of the present invention to provide a beverage container suitable for making cold or hot beverage. The beverage container includes a container body, an outer lid, a filter, and an inner lid. The top side of the container body is provided with an opening. A first receiving space is concavely provided in the container body, is in communication with the opening, and is configured for holding a liquid. A first connecting portion is provided on, and is adjacent to the top end of, the container body, and a second connecting portion is provided in the container body and corresponds in position to the top end of the first receiving space. The bottom side of the outer lid is provided with a third connecting portion and a fourth connecting portion. The third connecting portion is closer to the periphery of the outer lid than is the fourth connecting portion. The third connecting portion matches the first connecting portion so as to connect the outer lid to the container body. The filter is provided therein with a second receiving space. The top side of the filter is formed with a through hole so that a brewing material can be placed into the second receiving space through the through hole. In addition, the middle section of the filter is peripherally provided with at least one aperture, and a fifth connecting portion is provided on, and is adjacent to the top side of, the filter. The fifth connecting portion matches the fourth connecting portion so as to fix the top side of the filter to the bottom side of the outer lid. The inner lid is peripherally provided with a sixth connecting portion. The sixth connecting portion matches the second connecting portion so as to connect the inner lid to the container body at a position therein corresponding to the top end of the first receiving space. A primary liquid guiding hole and a secondary liquid guiding hole are provided on two opposite lateral sides of the inner lid respectively and are adjacent to the periphery of the inner lid, wherein the primary liquid guiding hole is larger than the secondary liquid guiding hole. Hence, by placing a brewing material into the second receiving space, connecting the filter to the outer lid, and connecting the outer lid to the container body, infusion of the brewing material can take place in the beverage container with either hot or cold water according to the user's preference or need. When the user determines that a proper brewing time has elapsed, the filter can be detached from the outer lid, and then the outer lid can be connected to the container body again, allowing the outer lid to keep the temperature of the beverage while the brewing material is kept from releasing unpalatable ingredients which may be extracted from the brewing material should the brewing material be soaked too long and which, if extracted, will damage the flavor of the beverage. Furthermore, once the filter is detached from the outer lid and the inner lid is connected to the container body, the beverage container can be tilted toward the secondary liquid guiding hole if the beverage container contains a hot beverage. Thus, the hot beverage will flow out through the relatively small secondary liquid guiding hole, and the user can sip the hot beverage without being burned. When containing a cold beverage, on the other hand, the beverage container can be tilted toward the primary liquid guiding hole so that the user can drink in large mouthfuls the cold beverage flowing out of the relatively large primary liquid guiding hole.

Another object of the present invention is to provide the foregoing beverage container, wherein the beverage container further includes a mat detachably connected to the bottom of the container body. The filter can be placed on the mat when the mat is not connected to the bottom of the container body, thereby preventing any liquid residue in the filter from wetting the surface of another object.

Still another object of the present invention is to provide the foregoing beverage container, wherein the top side of the inner lid is provided with at least one holding portion adjacent to the periphery of the inner lid. The at least one holding portion makes it easy for the user to connect the inner lid to the container body and detach the inner lid from the container body.

Yet another object of the present invention is to provide the foregoing beverage container, wherein the filter includes a hollow frame and at least one filter screen. The at least one aperture is formed on the periphery of the middle section of the hollow frame. The at least one filter screen is coated on the at least one aperture so that the brewing material in the second receiving space cannot pass through the at least one aperture. Thus, no residue of the brewing material will be found in the first receiving space after the filter is removed.

Yet another object of the present invention is to provide the foregoing beverage container, wherein the bottom side of the outer lid is further provided with a washer. Once the outer lid is connected to the container body, the washer is pressed between the top end of the container body and the bottom side of the outer lid to provide water-tightness between the outer lid and the container body. Therefore, should the beverage container be shaken while being carried around by the user, the liquid in the beverage container is prevented from leaking out.

### BRIEF DESCRIPTION OF THE SEVERAL VIEWS OF THE DRAWINGS

The structure as well as a preferred mode of use, further objects, and advantages of the present invention will be best understood by referring to the following detailed description of some illustrative embodiments in conjunction with the accompanying drawings, in which:

FIG. 1 is an exploded perspective view of the first implementation mode of a preferred embodiment of the present invention;

FIG. 2 is an exploded perspective view of the second implementation mode of the preferred embodiment of the present invention;

FIG. 3 is a sectional view of the first implementation mode of the preferred embodiment of the present invention; and

FIG. 4 is a partial sectional view of the second implementation mode of the preferred embodiment of the present invention.

### DETAILED DESCRIPTION OF THE INVENTION

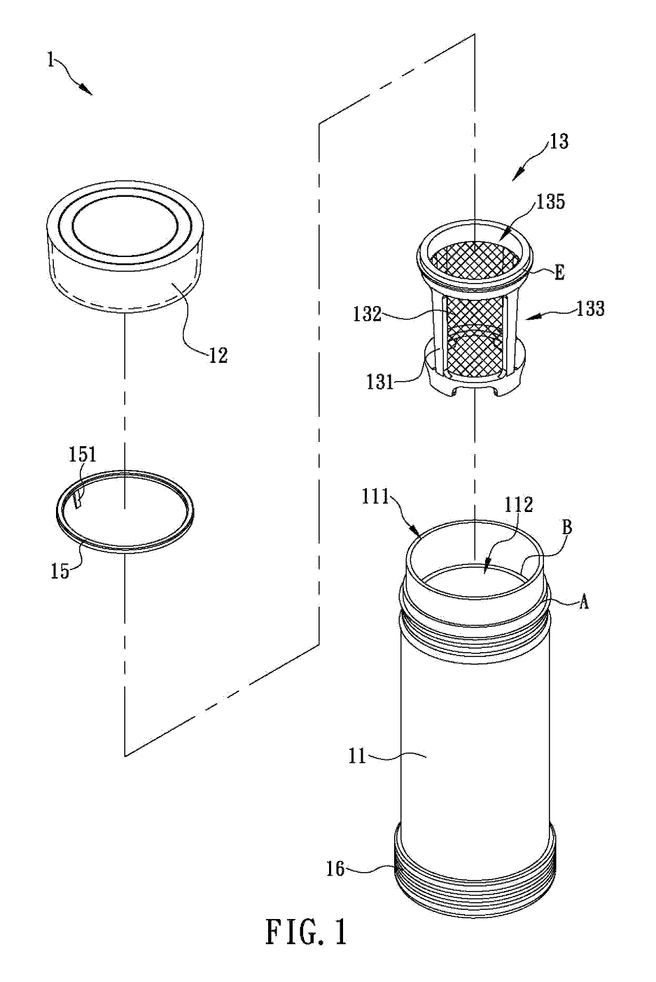

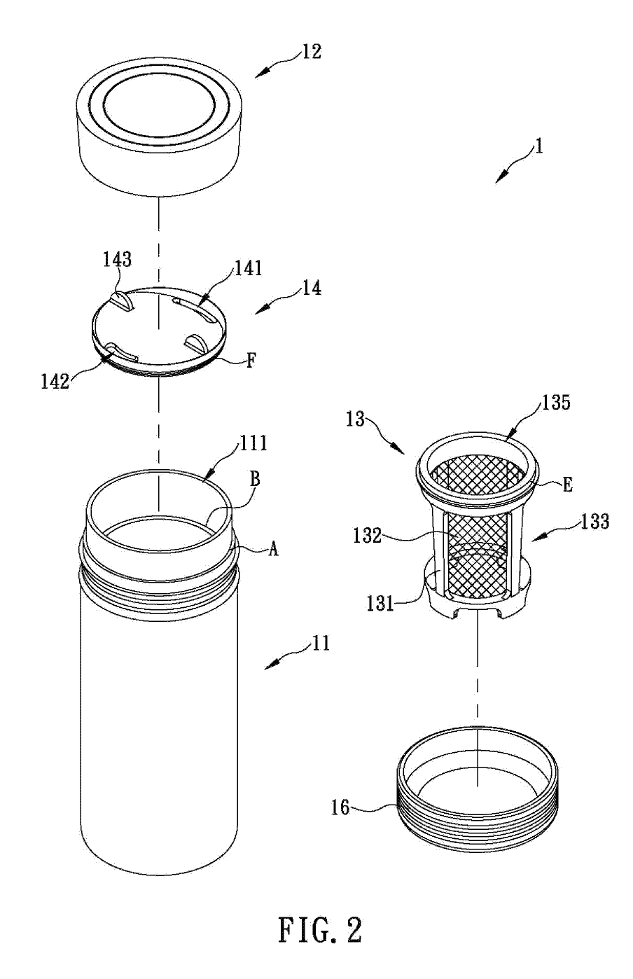

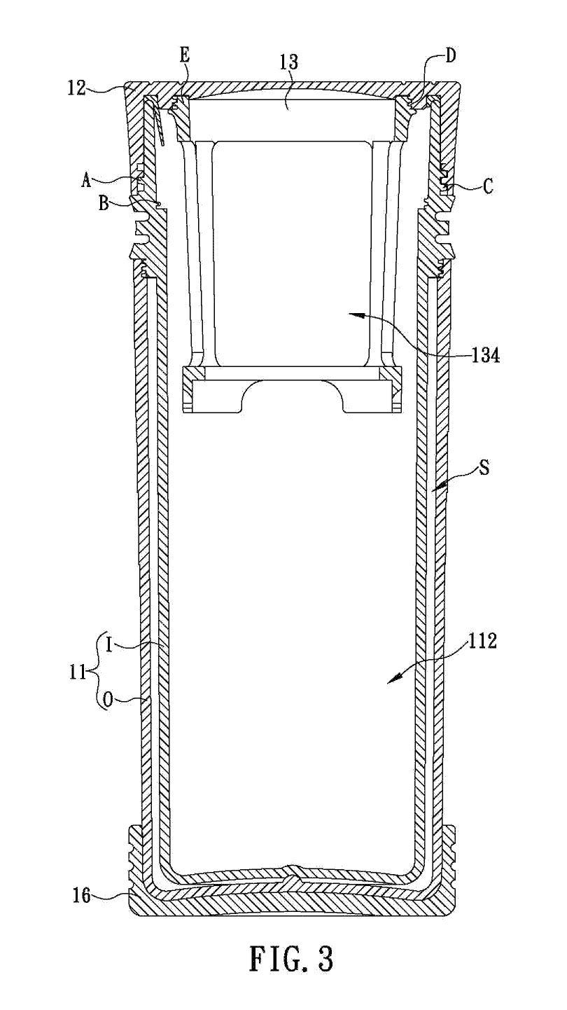

The present invention discloses a beverage container suitable for making cold or hot beverage. Please refer to FIG. 1 and FIG. 2 for exploded perspective views of two different implementation modes of a preferred embodiment of the present invention, wherein the beverage container 1 includes a container body 11, an outer lid 12, a filter 13, and an inner lid 14. As shown in FIG. 1 and FIG. 3, an opening 111 is provided on the top side of the container body 11, and a first receiving space 112 is concavely provided in the container body 11. The first receiving space 112 is in communication with the opening 111 and is configured for holding a liquid therein. In this preferred embodiment, the container body 11 is assembled from an inner cup I and an outer cup O. The first receiving space 112 is provided in the inner cup I, and the outer cup O is mounted around the outer periphery of the inner cup I. Once the inner cup I and the outer cup O are assembled together, a predetermined gap S exists therebetween to lower the rate of heat exchange between the interior and exterior of the container body 11. A first connecting portion A is provided on, and is adjacent to the top end of, the container body 11. A second connecting portion B is provided in the container body 11 and corresponds in position to the top end of the first receiving space 112. The bottom side of the outer lid 12 is provided with a third connecting portion C and a fourth connecting portion D, wherein the third connecting portion C is closer to the periphery of the outer lid 12 than is the fourth connecting portion D. In the first implementation mode of the preferred embodiment, the third connecting portion C matches the first connecting portion A so that the outer lid 12 can be connected to the container body 11, with the outer lid 12 covering the opening 111 of the container body 11. In this preferred embodiment, the first connecting portion A is provided on the outer periphery of the container body 11, but the location of the first connecting portion A is not limited thereto. For example, the first connecting portion A may be located on the inner periphery of the container body 11 instead while the outer lid 12 is designed as a plug. All such changes should not be deemed as departing from the scope of patent protection sought by the applicant. In this preferred embodiment, the bottom side of the outer lid 12 is further provided with a washer 15. When the outer lid 12 and the container body 11 are connected to each other, the washer 15 is pressed between the top end of the container body 11 and the bottom side of the outer lid 12 so as to provide water-tightness between the outer lid 12 and the container body 11. In this preferred embodiment, the washer 15 is protrudingly provided with a pulling tab 151. When the washer 15 is pressed between the top end of the container body 11 and the bottom side of the outer lid 12, the pulling tab 151 extends toward the first receiving space 112. This orientation of the pulling tab 151 allows a user to easily apply a pulling force to the pulling tab 151 and thereby detach the washer 15 from the outer lid 12 for cleaning.

In this preferred embodiment, the filter 13 includes a hollow frame 131 and at least one filter screen 132. The middle section of the hollow frame 131 is peripherally formed with at least one aperture 133. A second receiving space 134 is formed in the hollow frame 131. The top side of the hollow frame 131 is formed with a through hole 135 through which a brewing material (e.g., tea leaves or ground coffee) can be put into the second receiving space 134. Through the apertures 133, the second receiving space 134 is in communication with outside the filter 13. Once a brewing material is put in the second receiving space 134 and the filter 13 is submerged in a liquid, the liquid can flow into the second receiving space 134 through the apertures 133. Also, the ingredients extracted from the brewing material by the liquid can flow out of the filter 13 through the apertures 133. In this preferred embodiment, the filter screen 132 is coated on the apertures 133 to prevent the brewing material in the second receiving space 134 from passing through the apertures 133. However, the filter 13 of the present invention is not limited to the design described above. For example, the filter screen 132 may be dispensed with, and the hollow frame 131 may be formed with a large number of tiny apertures 133 to produce an effect equivalent to that of the filter screen 132. A fifth connecting portion E is provided on, and is adjacent to the top side of, the hollow frame 131. The fifth connecting portion E matches the fourth connecting portion D so that the top side of the filter 13 can be fixed to the bottom side of the outer lid 12. In the first implementation mode of the preferred embodiment, the filter 13 is received in the first receiving space 112 once the filter 13 is fixed to the outer lid 12 and the outer lid 12, in turn, is connected to the container body 11. Therefore, if the first receiving space 112 is loaded with a liquid, the liquid in the first receiving space 112 will flow through the apertures 133 into the second receiving space 134. Similarly, the ingredients extracted from the brewing material in the filter 13 will be released, along with the liquid, to the first receiving space 112 through the apertures 133. Thus, the first implementation mode of the preferred embodiment enables the beverage container 1 to be used for making various cold or hot beverages.

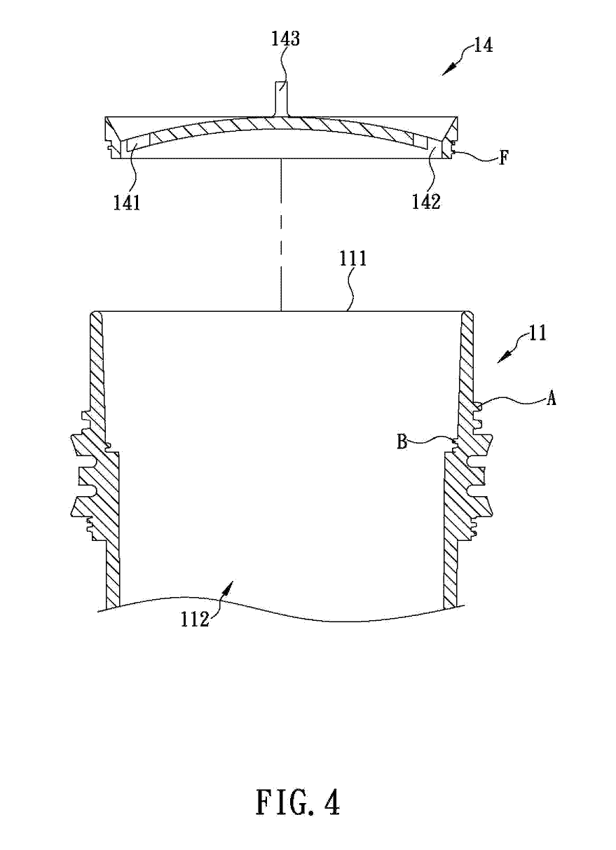

Reference is now made to FIG. 2 and FIG. 4. In the second implementation mode of the preferred embodiment, the filter 13 can be detached from the outer lid 12 so that, when the outer lid 12 is re-connected to the container body 11, the filter 13 and the brewing material contained therein will not be soaked in the liquid in the first receiving space 112. More particularly, when the user decides that the brewing time is up, the filter 13 can be detached and removed from the outer lid 12, thereby removing the brewing material, together with the filter 13, from within the container body 11, preventing the flavor of the beverage from deterioration which may otherwise result from leaving the brewing material in the beverage for a long time. In this preferred embodiment, the beverage container 1 further includes a mat 16 which is detachably connected to the bottom of the container body 11 (see FIG. 1 and FIG. 3). Once the mat 16 is detached from the container body 11 and the filter 13 is detached from the outer lid 12, the filter 13 can be placed on the mat 16 to keep whatever liquid left in the filter 13 from wetting the surface of another object (e.g., a tabletop which may otherwise be wetted if the filter 13 is directly placed thereon).

The inner lid 14 is peripherally provided with a sixth connecting portion F. The sixth connecting portion F matches the second connecting portion B so that the inner lid 14 can be mounted in the container body 11 at a position corresponding to the top end of the first receiving space 112. A primary liquid guiding hole 141 and a secondary liquid guiding hole 142 are respectively provided on two opposite lateral sides of the inner lid 14 and are adjacent to the periphery of the inner lid 14, wherein the primary liquid guiding hole 141 is larger than the secondary liquid guiding hole 142. The second implementation mode of the preferred embodiment is so designed that, if the beverage container 1 contains a hot beverage, the user can tilt the beverage container 1 toward the secondary liquid guiding hole 142 in order for the hot beverage to flow out through the relatively small secondary liquid guiding hole 142 and be sipped without burning the user. If the beverage container 1 contains a cold beverage, the user can tilt the beverage container 1 toward the primary liquid guiding hole 141 in order for the cold beverage to flow out through the relatively large primary liquid guiding hole 141 and be drunk in large mouthfuls. In this preferred embodiment, two holding portions 143 are additionally provided on the top side, and adjacent to the periphery, of the inner lid 14. The holding portions 143 are configured to facilitate the mounting and removal of the inner lid 14 to and from the container body 11.

In conclusion, the first implementation mode of the preferred embodiment is such that the beverage container 1 can be used to make various cold or hot beverages by putting a brewing material into the second receiving space 134, connecting the filter 13 to the outer lid 12, pouring hot or cold water into the container body 11 as desired or needed, and then connecting the outer lid 12 to the container body 11 so as for the brewing material to be infused in the beverage container 1. The second implementation mode of the preferred embodiment is such that the beverage container 1 can serve the beverage therein safely and to the user's heart's delight. More specifically, once the user determines that a proper brewing time has elapsed, the user can detach the filter 13 from the outer lid 12 and re-connect the outer lid 12 to the container body 11 to not only allow the outer lid 12 to keep the temperature of the beverage, but also prevent the brewing material from releasing unpalatable ingredients which may be extracted if the brewing material is let soaked for an excessive amount of time and which will compromise the flavor of the beverage if extracted. In addition, once the filter 13 is removed from the outer lid 12 and the inner lid 14 is connected to the container body 11, the user may either gulp a cold beverage through the relatively large primary liquid guiding hole 141 or sip a hot beverage through the relatively small secondary liquid guiding hole 142 without the risk of being burned by the high-temperature beverage. Therefore, whether the beverage in the beverage container 1 is cold or hot, the user can enjoy it just the same.

While the invention herein disclosed has been described by means of specific embodiments, numerous modifications and variations could be made thereto by those skilled in the art without departing from the scope of the invention set forth in the claims.

What is claimed is:

1. A beverage container suitable for making cold or hot beverage, comprising:
a container body having a top side provided with an opening, the container body being concavely provided with a first receiving space, the first receiving space being in communication with the opening and configured for holding a liquid therein, the container body being provided with a first connecting portion adjacent to a top end of the container body, the container body being further provided therein with a second connecting portion corresponding in position to a top end of the first receiving space;
an outer lid having a bottom side provided with a third connecting portion and a fourth connecting portion, the third connecting portion being closer to a periphery of the outer lid than is the fourth connecting portion, the third connecting portion matching the first connecting portion so that the outer lid is connectable to the container body;
a filter formed therein with a second receiving space, the filter having a top side formed with a through hole through which a brewing material can be placed into the second receiving space, the filter having a middle section peripherally provided with at least one aperture, the filter being provided with a fifth connecting portion adjacent to the top side of the filter, the fifth connecting portion matching the fourth connecting portion so that the top side of the filter can be fixed to the bottom side of the outer lid; and
an inner lid having a periphery provided with a sixth connecting portion, the sixth connecting portion matching the second connecting portion so that the inner lid is connectable to the container body at a position therein corresponding to the top end of the first receiving space, the inner lid having two opposite lateral sides respectively provided with a primary liquid guiding hole and a secondary liquid guiding hole, both said liquid guiding holes being adjacent to the periphery of the inner lid, the primary liquid guiding hole being larger than the secondary liquid guiding hole.

2. The beverage container of claim 1, further comprising a mat detachably connected to a bottom of the container body, wherein the filter can be placed on the mat when the mat is not connected to the bottom of the container body.

3. The beverage container of claim 2, wherein the inner lid has a top side provided with at least one holding portion adjacent to the periphery of the inner lid.

4. The beverage container of claim 3, wherein the filter comprises a hollow frame and at least one filter screen, the at least one aperture being formed on a periphery of a middle section of the hollow frame, the at least one filter screen being coated on the at least one aperture.

5. The beverage container of claim 4, wherein the bottom side of the outer lid is further provided with a washer, the washer being pressed between the top end of the container body and the bottom side of the outer lid when the outer lid is connected to the container body.

6. The beverage container of claim 5, wherein the washer is protrudingly provided with a pulling tab, the pulling tab extending toward the first receiving space when the washer is pressed between the top end of the container body and the bottom side of the outer lid.

7. The beverage container of claim 6, wherein the container body is assembled from an inner cup and an outer cup, the first receiving space being provided in the inner cup, the outer cup being mounted around an outer periphery of the inner cup, there being a predetermined gap between the inner cup and the outer cup when the inner cup and the outer cup are assembled together.
